(19) United States
(12) Patent Application Publication
(10) Pub. No.: US 2003/0136709 A1
(43) Pub. Date: Jul. 24, 2003

(54) Method and apparatus for determining the origin of postal deposits

(76) Inventor: Katsusuke Peter Asanuma, Escondido, CA (US)

Correspondence Address: BRUCE D. JIMERSON, 27375 Coolwater Ranch Rd., Valley Center, CA, 92082, US

(21) Appl. No.: 10/052,708

(22) Filed: Jan. 23, 2002

(51) Int. Cl. B07C 1/00; B07C 5/342

(52) U.S. Cl. 209/3.3; 209/584; 209/900

(57) ABSTRACT

The system of the present invention has as its objective the marking of mailpieces to indicate the origin of the depository. This function is carried out at two levels; in the field, by segregating at the time of collection, and subsequently, via pre-processing in the Post Office where previously segregated items are marked with an identifying code before they are merged with other mail into the normal distribution procedures.

### FIELD OF THE INVENTION

Prior art methods for retrieval and sorting of mail deposited at remote locations provide no information that can be used to identify the depository. In a typical route, collected mail will be placed into bags or other containers and transported to a central processing station (e.g., a local post office) where it is mixed with other mail and processed according to destination. It has recently become important to be able to trace anonymously mailed letters and packages to their source. The present invention relates to a system for determining the origination point of mail deposited in postal boxes.

### DESCRIPTION OF PRIOR ART

Methods for control of bulk distributing systems where the containers carry specific information with respect to their destination are well known in the art. Automatic sorting and processing wherein various articles are identified by machine are also common prior art techniques, as for example in baggage routing and postal processing systems. Mail sorting devices, stamp cancelling apparatus and priority marking means are similarly all well known in the industry. Prior art techniques for marking and tracking in accordance with significance indicators are directed exclusively to that aspect of postal procedures dealing with an items destination. The references listed below are exemplary of the current state of the art as to their teachings in regard to the present invention:

1. U.S. Pat. No. 3,573,748 issued to William M. Holm on Apr. 6, 1961 provides a system for sorting and gathering together articles of like distribution.

2. U.S. Pat. No. 3,785,510 issued to Wilhelm Grooteboer on Jan. 15, 1974 is concerned with a conveyer distribution system which can be used for postal items.

3. U.S. Pat. No. 3,880,298 issued to James D Harbegger et al on Apr. 19, 1975 describes an endless loop sorting conveyor.

4. U.S. Pat. No. 3,398,435 issued to Kasuyoski Suda et al on Feb. 17, 1976 is primarily concerned with the detection and cancelling of postage stamps.

5. U.S. Pat. No. 4,058,217 issued to Richard Vaughan on Nov. 15, 1977 is directed to a sorting apparatus that reads an electronically readable indicia.

6. U.S. Pat. No. 4,328,962 issued to Roy Akers on May 11, 1982 describes an envelope feeder that operates in conjunction with sorting machines.

7. U.S. Pat. No. 5,568,392 issued to Brett Flickner on Oct. 22, 1996 is directed to the mechanics of an edge marking machine.

8. U.S. Pat. No. 5,917,925 issued to Lewis J Moore on Jun. 29, 1999 describes a system for marking and tracking mailpieces to prevent counterfeiting and diversion of goods.

9. U.S. Pat. No. 6,276,535 issued to John Winkelman on Aug. 21, 2001 relates to a mailpiece sorting apparatus.

The above references neither individually nor collectively relate to source identification; rather they are concerned with processing and delivery to a specified destination. Being so orientated, they neither anticipate nor resolve the problem addressed by the present invention, namely the source location of terrorists mailings. Recent events have created an urgent need to identify the postal box where dangerous or threatening mail has been deposited. This potential for harm extends not only to the recipient (the addressee) but to all persons likely to handle the item in-route as well as other persons in proximity. The actual problem posed is that of providing a means for reverse tracing deposited mail to its origin. Accordingly,

A primary object of the invention is to provide a means for marking items of post with an origin tag before the distribution process is begun:

Another object of the invention is to provide a procedure for segregating collected mail into separate pouches indicative of the pick-up location:

Another object of the invention is to provide a means for coding each piece of collected mail with an indicator that relates it to a particular pick-up pouch:

Another object of the invention is to provide an anti-terrorist functionality for frustrating repeated use of certain techniques to introduce dangerous items into the postal system;

Another object of the invention is to provide a means for generating critical “stakeout” information to authorities for the purpose of apprehending persons illegally using mail deposit boxes to introduce dangerous materials into the postal system.

Other objects and advantages of the invention will be obvious from the detailed description of a preferred embodiment given herein below:

### SUMMARY OF THE INVENTION

The present invention provides an indicia marking system and procedure for determining the depository of a mailed item for the purpose of tracking and tracing dangerous mailpieces. The methodology is particularly suited to identifying a specific location from among a number of geographically diverse locations. In a preferred embodiment, field segregated collected mail is subsequently batch processed at the Post Office to apply coded markings indicative of the collection point.

### DESCRIPTION OF THE DRAWINGS

FIG. 1 illustrates the segregation collecting procedure applicable to a route covering geographically separated mail depositories

FIG. 2 is a block diagram showing how the segregated items are serially batch processed to provide location indicia

FIG. 3 shows a block diagram of the apparatus used to batch pre-process segregated items.

### DETAILED DESCRIPTION OF A PREFERRED EMBODIMENT

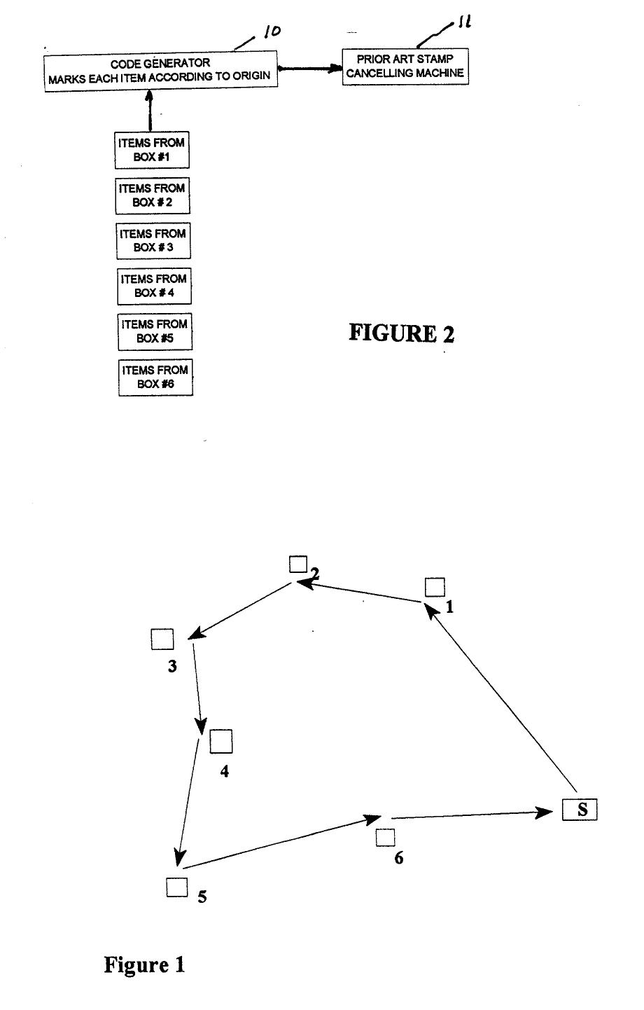

Adverting to the drawings, and particularly FIG. 1, the method of practicing the invention is illustrated in terms of the procedures to be carried out during the initial pick-up and processing of deposited items of mailing (hereinafter preprocessing). The route depicted in the example shown in FIG. 1 has six pick-up destinations, beginning at the Post Office labeled S, to each of the depositories labeled 1 through 6 and returning to S. In the customary prior art procedures, the collected items are sacked into pouches and transported to the Post Office S with no consideration being given as to which mail is collected from a particular depository. All mail from the route is thus treated equally, with no postal processing methodology in place for segregation or identification of the box from whence items are received. As a consequence, critical information needed to trace a particular piece of mail to the source of deposit is lost at the outset.

Although it is possible to source code mail at the time and place of collection, such procedures are timely and troublesome to implement. In the present invention, collected items are segregated into separate transportation pouches, each being labeled to correspond with a particular pick-up station. Thus, mail from Box 1 is collected and placed into a pouch labeled “one,” mail collected at Box 2 is placed into a pouch labeled “two” etc, so that every item can, at this phase of the processing, be linked with a particular depository.

The segregation pouches containing items from each pick-up station are then transported to Post Office S. Prior to initiating the conventional stamping and sorting procedures, mailpieces are pre-processed in accordance with the present invention as illustrated in FIG. 2. In a preferred embodiment, the identifying address of every pouch is stored in a special code generating unit 10 which functions to mark each item in congruence therewith. For example, all items contained in pouch one would constitute a first batch to be placed into a transport conveyor; code generator 10 would be set, either automatically or manually, to print the same mark on each item of the batch. The items from pouch two are next batch processed, code generator 10 being incremented so that mailpieces in batch two are appropriately marked alike, and so forth. Once an item is marked with an identifying source code, the pre-processing is complete, and normal processing begins in the usual fashion, ultimately culminating with delivery at the address of destination.

The location of the source depository becomes significant if the item proves to be dangerous. The information can be used in numerous ways, for example to identify and “stake out” depositories likely to be again used by terrorists or to gain descriptive leads as to the identity of frequenting users. Once it is known that a given mail box has been used as a source of terrorist mailings, it can be rigged with camera equipment, deposited items can be screened, and persons questioned with regard to suspicious activities; all of which can be carried out more efficiently on a small scale involving only a limited number of mail boxes.

It will be understood that the methods and apparatus used to practice the essential steps can take many forms. Thus, instructions can be provided to the code generator 10 in any number of ways, such as manual input by a human, automatically by sensing an identifying encryption on the first item of a batch, or a sequencing algorithm that responds to a set of instructions that inform the code generator that a particular batch from a particular mail-drop is being processed. The source identifier on the mailpiece may be printed as a visibly recognizable numerical address, or disguised in the form of an obscure marking known only to authorities such as a machine readable format or barcode, the significance of which is not generally made known to the public. Invisible markings with special inks can be used to maintain the secrecy of invention even though it is commonly in-place and practiced throughout the postal system. The encrypted information can be printed anywhere upon the item that does not interfere with the destination sorting process. Moreover, the legend can also include additional information such as the date and time of processing as is customarily done in cancelling machines. Where bulk deposits are involved, it is also desirable to scan the batch for common characteristics and store this information during preprocessing. For example, if one item of a bulk deposit of concurrently mailed items is discovered to contain dangerous materials, this information could be used to divert all other similar items that have yet to be delivered as well as any future mailings containing a similar characteristic.

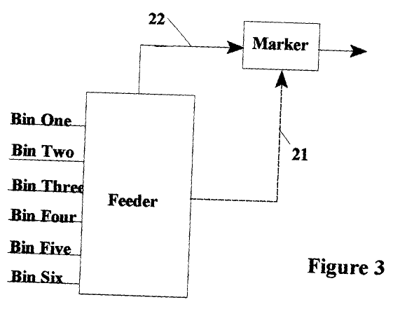

In the configuration shown in FIG. 3, the contents of the various containers are loaded into separate bins which are selected for processing in- turn by the feeder. For example the mail collected in pouch one is placed in bin one, the mail contained in pouch two, in bin two, and so forth. The Feeder is adapted to sequentially select each bin and feed its contents to the printer via path 22 which can be considered to represent any number of prior art serial transport conveyors such as the type commonly used in automated stamp cancelling apparatus. At the time a bin is selected, the feeder simultaneously generates a signal on line 21 indicative of the bin number. The marker contains a logic circuit that responds to the bin number signal directing the printing mechanism to imprint a predetermined code on all items of the batch. When the contents of the selected bin are exhausted, the feeder makes another selection and transmits a different signal on line 21 that corresponds to the newly selected bin, and so on, each item of mailing thus being imprinted in accordance with the container into which it was originally segregated at the time of collection.

The source marking may also be incorporated into the stamp cancelling machinery itself, the procedure being modified to the extent necessary to batch process the contents of each pouch with the ID source included as part of the cancellation date. In this alternative, mailpieces from each pouch are loaded into separate bins as shown in FIG. 3, the Feeder functioning in this alternative to communicate with the cancelling machine rather than a special marker.

The invention can also be used for the purpose of tracking, monitoring, and locating lost mail as well as validating the delivery of sensitive, valuable and priority items. Thus although preferred embodiments of various implementations have been shown and described, it will be understood that they are exemplary only and that the invention is not limited thereby, and that numerous changes, modifications and substitutions may be made without departing from the spirit of the invention.

What is claimed is:

1. A method for identifying the location of a mail drop comprising the steps of:
collecting items deposited at different locations into segregating containers;
transporting said containers for delivery to a processing station;
processing the contents of each container as a segregated batch.

2. The method recited in claim 1 wherein said processing step comprises:
marking the items of each of said segregating containers with an indicator that will identify the items delivered in one container from the items of all other containers.

3. The method recited in claim 1 wherein the step of collecting deposited items is carried out using pre-labeled containers that identify each such container with a particular pick-up station.

4. The method recited in claim 1 wherein the step of batch processing comprises:
Providing an indicator for identifying mailpieces according to said segregating containers;
Marking said mailpieces to identify the segregating container in which it is delivered to said processing station.

5. A process for tracing mail to the source of its postal depository comprising:
adding indicia to each item of mail collected from a depository prior to its integration into the mail processing procedures so as to identify the location of said depository;
reading said location indicia to determine the source of a mailpiece suspected to contain illegal contents.

6. The method recited in claim 5 wherein the indicia adding process comprises marking mail items with a code that identifies the location where the mail was first introduced into the postal system.

7. A source location system comprising:
a plurality of postal mail collection containers;
means for labeling each of said collection containers to correspond with a particular mail depository;
delivery means for transporting mail segregated into separate collection containers to a processing station;
indicia marking means for adding information to each item of mail in accordance with the collection container into which it is segregated.

8. The apparatus recited in claim 7 wherein said indicia marking means includes:
location code generating means for providing a unique indicator for all mail pieces delivered in the same collection container, and;
preprocessing means for operating upon said segregated items of mail so as to imprint said unique location code on each piece of segregated mail prior to its integration with other mail.

9. The apparatus recited in claim 9 wherein said location code generating means is responsively connected to communicate with batch processing information indicative of the segregation containers from which the batch items were retrieved.

10. The apparatus recited in claim 7 wherein is included:
feeder means for selecting segregated batches of mail for identical marking indicative of the location of the depository location;
Signal means responsive to the batch depository for updating said indicia marking means in accordance therewith.
